(19) United States
(12) Patent Application Publication
(10) Pub. No.: US 2003/0179720 A1
(43) Pub. Date: Sep. 25, 2003

(54) Congestion control in wireless telecommunication networks

(75) Inventor: Renaud Cuny, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/419,252

(22) Filed: Apr. 21, 2003

Related U.S. Application Data
(63) Continuation of application No. PCT/FI01/00830, filed on Sep. 21, 2001.

(30) Foreign Application Priority Data
Oct. 20, 2000 (FI) 20002320

(51) Int. Cl. H04B 7/00

(52) U.S. Cl. 370/310

(57) ABSTRACT

The invention discloses a method of controlling congestion in a wireless telecommunication system for packet transfers between a mobile terminal (100) and a TCP sender (310) via the Internet, for example. The system comprises a packet switched network and radio network controller (RNC) (130) that hosts a plurality of uplink (330) and downlink (320) buffers wherein a pair of uplink and downlink buffers are associated with a specific communication channel. In a first aspect of the invention, a mobile terminal (100), via the RNC (130), receives data traffic from a TCP sender (310) whereby the packet flow is transiently stored in the downlink buffer while waiting to be forwarded to the mobile terminal (100). When the mobile terminal (100) returns acknowledgements (ACKs) to the TCP sender (310) via the associated uplink buffer (330) in the RNC, the Advertised Window (AW) in the ACK header is modified according to the amount of data in the associated channel's downlink buffer where the ACK is then forwarded to the TCP sender (310). In another aspect of the invention, the ACKs are delayed in the associated uplink buffer (330) for a period of time prior to being forwarded to the TCP sender (310). In still another aspect of the invention involves performing a combination of delay and modification of the AW of ACKs prior to being forwarded to the TCP sender (310).

### FIELD OF INVENTION

The present invention relates generally to wireless telecommunication networks and, more particularly, to a method and system for reducing data packet congestion in wireless packet switched networks.

### BACKGROUND OF THE INVENTION

The tremendous growth of wireless telecommunications industry is driven in large part by the demand for mobile access voice services which are primarily enabled by second generation systems such as GSM (Global System for Mobile Communication) and TDMA (Time Division Multiple Access). Such demand continues to show high growth as more and more people switch to mobile communications for its advantage of providing convenient un-tethered access and readily available access to telecommunication services by those in e.g. rural or developing areas where traditional telecommunication infrastructure has not been widely established.

Another area demonstrating tremendous growth is in Internet use where users increasingly discovering the wealth of information available online and that portion of the Internet comprising the World Wide Web (WWW). Accordingly, Internet content and the number of services provided thereon have increased dramatically and is projected to continue to do so for many years. The Internet has become increasingly prevalent where more and more people are coming to rely on the medium as a necessary part of their daily lives. Presently, the majority of people typically access the Internet with a personal computer using a browser such as Netscape Navigator™ or Microsoft Internet Explorer™.

The demand for data services, fueled by the Internet, has led to the convergence of Internet with the mobile world in what is called the Wireless Internet. To fulfill this promise, early efforts have been made to bring wireless data access that have been adapted for use with second generation systems such as Wireless Application Protocol (WAP), for example. However, a maximum data rate of approximately 14 kbps for second generation systems such as GSM currently limit the data transfers to basic text-based or low-bandwidth applications. Further enhancements such as High Speed Circuit Switched Data (HSCSD) and General Packet Radio Service (GPRS) specified for use with the GSM standard have been introduced to improve bit rates to about 64 kbps. However, this is still short of what is needed for high-bit-rate wireless data services such as the transmission of simultaneous high quality voice and video, multimedia, and high bandwidth Internet access.

To provide even higher bit rates, so-called third generation systems, also referred to as UMFS (Universal Mobile Telecommunication System), were developed to provide high speed packet data transfers which will enable a whole host of lucrative applications from video telephony to downloading movies, for example. UMTS provides a flexibility that permits operators to choose among core networks such as GSM, IS-41, or an emerging alternative of an all IP-based core network to operate with a radio access network such as WCDMA (Wideband Code Division Multiple Access—standardized by 3GPP or 3^{rd} Generation Partnership Project). The underlying core network handles internal signaling for inter-working activities such as MSC (Mobile Switching Center) functions and cell handover. Moreover the core network can operate independently of the radio access network. The core network in UMTS can include a so-called hybrid combination of circuit switched and packet switched networks where rates of up to 384 kbps on circuit switched connections and 2 Mbps on packet switched connections can be achieved. The hybrid network permits the handling of circuit switched voice calls on the circuit switched network and IP-based data traffic on the packet switched network. FIG. 1 illustrates a basic functional block diagram of a UMTS network using a GSM core network. The network has the ability to route conventional circuit switched voice calls while simultaneously having the ability to handle data traffic via a packet switched network. A mobile terminal 100 is shown having the capability for radio communication over a WCDMA air interface to send and receive voice calls and data connections. As an example of a circuit switched operation, a voice call originating from the PSTN 120 (Public Switched Telephone Network) is routed to a 3G MSC 115 that provides switching functions and is equipped for use together with the packet network via an HLR 110 (Home Location Register) and RNC 130 (Radio Network Controller). The HLR is a functional component that is located in the user's home system that retains the user's service profile, which is created when the user first subscribes to the system. The service profile includes information on allowed services, permitted roaming areas, and the existence of supplementary services such as call forwarding etc. To reach mobile terminal 100 the call is routed from the MSC to the BSC 105 (Base Station Controller) for wireless transmission to the mobile terminal. The BSC 105 is part of a BSS (Base Station Subsystem) that includes a plurality of base stations that form the service area for the network. The BSS also provides transcoder, submultiplexer and cellular transmission functions for the network and establishes a connection to the packet switched subsystem via link 108. Calls originating from the mobile terminal 100 to the PSTN 120 are carried out via the BSC 105 and MSC 115 to the Internet or PSTN receiver.

Data traffic transmitted between the mobile terminal 100 and the Internet 160 is routed through the packet network during data transfers. As an illustration, the mobile terminal 100 may make a request to download a data file hosted on an origin server that is accessible via the Internet 160. The file is first routed to a GGSN 150 (Gateway GPRS Support Node) which acts as an interface between the mobile network and external IP networks such as the public Internet or other GPRS networks. The data is then routed through an SGSN 140 (Service GPRS Support Node) that, in effect, functions like an MSC for the packet switched network. The SGSN 140 performs mobility management functions such as querying the HLR 110 to obtain the service profile of GPRS subscribers and detecting and performing registration of new GPRS subscribers entering the service area. To complete the transfer, the packet data is routed from the SGSN 140 to the RNC 130 for wireless transmission to the mobile terminal 100.

Data transfers are packet-based and are typically performed over a transfer protocol in which packets are transferred in units known as datagrams. One very commonly used transfer protocol is TCP (Transmission Control Protocol). As known by those skilled in the art, TCP provides highly reliable host-to-host transmissions over packet-switched communication networks which are used by applications that need a reliable connection-oriented transport service over the relatively unreliable Internet Protocol (IP). The combination of TCP and IP is referred to as TCP/IP and has, in large measure, become the foundation upon which the Internet and the WWW are based. This is reflected in the fact that the majority of Internet applications support the TCP/IP transport mechanism. The segment format in IP datagrams includes a header that comprises, among other things, a 128 bit source and destination address in IP version 4 (IPv4).

FIG. 2 shows an exemplary IP packet format with associated fields for Internet Protocol version 4 (IPv4). In the packet header, field 100 indicates the version of IP of the packet currently used. The version indicator gives compatibility information to the receiving host with regard to the version in use e.g. IPv4 or the next generation protocol IPv6. IPv6 is intended to gradually replace IPv4 and fixes a number of deficiencies, most notably, the limited number of addressable nodes in IPv4. Current trends dictate that many more available addresses will be needed by all the new machines being added to the Internet each year. Other improvements are in the areas of routing and network autoconfiguration will probably be included when the standard is finalized. Field 105 is the EP header length (IHL) which indicates the datagram header length in 32-bit words in which the total length is contained in field 115. Field 120 is an identification field where the current datagram is identified by an integer which enables the various datagram fragments can be pieced together. Field 125 is a 3-bit field of which the two low-order (least-significant) bits control the fragmentation. The low-order bit specifies whether the packet can be fragmented and the middle bit specifies whether the packet is the last fragment in a series of fragmented packets. The third or high-order bit is not currently used. Field 130 is the Fragment Offset which indicates the position of the fragment's data relative to the beginning of the data so that the original datagram can be properly reconstructed.

Field 135 is a Time-to-Live counter value that prevents packets from looping endlessly and works by discarding the packet when the counter counts down to zero. Field 140 indicates which upper-layer protocol receives incoming packets after the IP processing is complete. Field 145 is the Header Checksum field whose task is to check for errors in the EP header. Field 150 is the Source Address which specifies the sending node. In IPv4 there are only 2 to-the-power 32 or approximately 4 billion (4000 million) nodes that can be uniquely identified. Although on the surface this appears to be a large number, it becomes easier to understand when one considers that it is less than the human population on earth. IPv6 significantly increases the number of uniquely identifiable nodes to 2 to-the-power 128 or approximately many orders of magnitude of the population on earth. Likewise, the Destination Address for the packet of the receiving node is specified in field 155. Field 160 indicates whether there is support for various options such as security etc. and field 165 is a Data field which comprises upper layer information plus data from the application layer such as HTTP or SMTP, for example.

Transferring data packets over a radio link poses some difficulties not experienced in wired connections such as with host-to-host computers. One difficulty is that the radio link is relatively error prone in that bit-error-rates tend to be high when compared to a wired connection. Another serious consideration is that radio resources are typically limited thus making the transfer of data over radio links inherently slower than with wired connections. By way of example, UMTS packet data transfers over a radio link can reach rates of up to 2 Mbits/s as compared to wired connection rate of up to 34 Mbits/s. One way of improving the spectral efficiency in transferring IP packets is to implement a form of header compression. Header compression compresses the header of the protocol datagrams so that fewer bits are sent per packet thereby reducing the packet loss rate and consumed bandwidth by lowering the overhead per packet. This is typically done by extracting redundant information from consecutive headers in the data stream. As an illustration of the idea of using header compression for improving spectral efficiency, the overhead associated with packet headers is borne out in the fact that the size of TCP/IP headers is at least 40 bytes for IPv4 and about 60 bytes for IPv6, while the payload of EP packets for voice service is about 20 bytes.

Closer examination of the headers during a transmission reveal that roughly half of the information contained in the headers remains constant. The unchanging fields represent redundant information that need not be transmitted since they can be regenerated by the receiver. This has given rise to a whole host of packet header compression techniques that utilize various algorithms to compress, decompress and perform error recovery that operate with EP together with upper layer protocols such as TCP and UDP (User Datagram Protocol. One well known compression protocol is PDCP (Packet Data Convergence Protocol). It is specified for use in UMTS systems by 3GPP in which header compression and decompression for IPv4 and IPv6 are supported.

The differences in data rates between the wireless network and wired connections can lead to difficulties when downloading datagrams originating on the Internet, for example. Data traffic traveling through the core network typically arrive at the RNC 130 at a much faster rate than they can be transmitted over the radio connection to the mobile terminal 100. In an ideal scenario, the datagrams are briefly stored in a buffer in the RNC 130 without overflowing until which time they can be sent to the terminal. But problems can occur when the transfer rate of the radio link is significantly lower than that of the incoming datagrams from the core network, which can happen due to a variety of factors such as excessive cell interference increasing bit error rates and thus retransmissions. As known by those skilled in the art, this is referred to as congestion which can happen in wired networks involving a host-to-host IP or ATM connections. Congestion in network transmissions for relatively short periods are somewhat common since a TCP sender, in an effort to improve transmission efficiency, may continuously increase its data rate until it reaches network capacity. In wireless telecommunication systems having relatively long end-to-end delays, the tendency of TCP senders to increase data rates may lead to excessive congestion which may result in packet losses when the RNC buffer overflows.

The issue of network congestion due to mismatches in transfer and receiving rates between wired computer connections has arisen before. The very nature of the Internet where ‘connectionless’ remote computers communicate with each other from around the globe will inevitably cause data rates to differ. The TCP protocol includes a mechanism to reduce congestion by adapting the data rate by which the sender transmits to the available bandwidth experienced in the path between the sender and the receiver. One popular TCP optimization method is known as Random Early Detection (RED) which is typically used in routers to avoid global synchronization of TCP flows. Although these TCP optimization methods may work well in router-to-router configurations, there is no current solution implemented in UMTS for effectively reducing congestion when interfacing with UMTS packet switched networks i.e. packet transfers from an Internet origin server to the mobile terminal 100 via the RNC 130. By way of illustration, routers generally have a single global buffer that stores data received from other routers in which data is typically stored in a FIFO scheme. As the buffer reaches its capacity, an attempt to synchronize the data flow is made by reducing the sending rate. This type of synchronization does not work well with the buffer arrangement in the RNC because each channel has its own capacity limit that is logically divided in the buffer memory. This means that packet losses are channel dependent and different TCP flows are not likely to get synchronized in the common global buffer structure used in routers.

### SUMMARY OF THE INVENTION

Briefly described and in accordance with an embodiment and related features of the invention, in a system aspect a wireless telecommunication system comprising a packet switched network for sending and receiving data traffic between a mobile terminal and a data packet sender, said system being

characterized in that

the system comprises a plurality of uplink buffers and downlink buffers wherein each uplink and downlink buffer pair is associated with a specific communication channel for use by the mobile terminal, and wherein the system includes means for controlling excessive congestion of packets accumulating in said buffers during a data transfer.

In a method aspect of the invention, a method of controlling packet congestion in a wireless telecommunication system comprising a packet switched network for sending and receiving data traffic between a mobile packet receiver and a data packet sender, and wherein the system further comprises a plurality of uplink buffers and downlink buffers wherein each uplink and downlink buffer pair is associated with a specific communication channel for use by the mobile terminal during a data transfer, said method is characterized in that congestion caused by packets accumulating in said buffers during the data transfer is controlled by instructing the sender to reduce the rate at which packets are transmitted via an acknowledgement message (ACK) forwarded by the mobile packet receiver to the packet sender.

### BRIEF DESCRIPTION OF THE DRAWINGS

The invention, together with further objectives and advantages thereof, may best be understood by reference to the following description taken in conjunction with the accompanying drawings in which:

FIG. 1 shows a functional block diagram of a UMTS network;

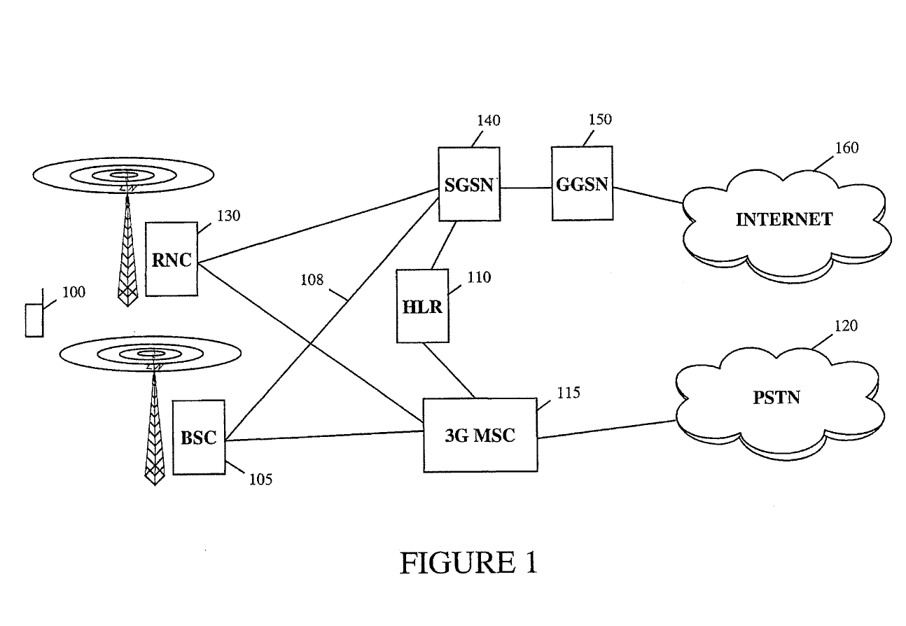

FIG. 2 shows an exemplary IP packet format and associated fields;

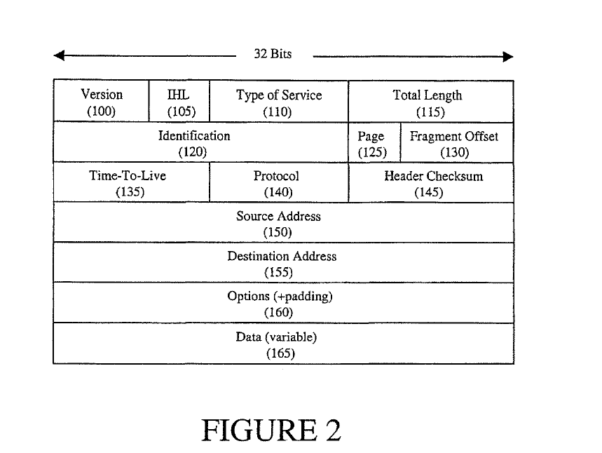

FIG. 3 illustrates the packet communication path between a TCP sender and the RNC in the UMTS system;

FIG. 4 shows the buffer arrangement in the RNC; and

FIG. 5 is a flow diagram illustrating the congestion control process in accordance with the present invention.

### DETAILED DESCRIPTION OF THE INVENTION

As previously mentioned, the TCP/IP protocol enables the sender to attempt to control congestion by adjusting the flow rate of packets in accordance with the current conditions in the network and in the receiver. A TCP sender considers packet losses to be a result of congestion and therefore attempts to slow down the rate of transmission. In fact, the sender assumes congestion has occurred when it does not receive, from the TCP receiver, acknowledgements that are associated with the packets sent within a certain time period. The acknowledgment message from the receiver also contains a field referred to as the Advertised Window (AW) that specifies a suitable amount of data for which the sender can transmit to avoid overflow the buffer at the receiver. In the wireless environment, normal TCP methods for relieving congestion in the network, such as RED, do not work particularly well because of the individual channel PDCP buffer arrangement in the RNC (Radio Network Controller) and the latency inherent from the wireless link.

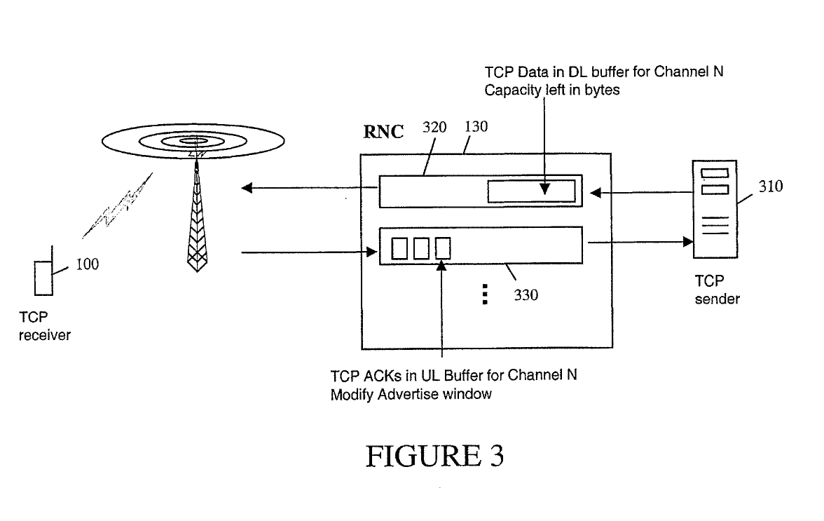

FIG. 3 shows an embodiment of the invention illustrating the path where downloaded packets enter the PDCP buffer arrangement in the UMTS system. Packets originating from a TCP sender 310 enter a global shared memory in the RNC 130. The shared memory is comprised of a plurality of logically divided channel buffers. Each channel has buffer space that is further separated into two sections i.e., in a situation where the mobile terminal downloads data, a downlink buffer reserved for incoming packets 320 and uplink buffer e.g. for outgoing acknowledgment messages 330 (ACK) from the mobile terminal 100. For simplicity of illustration, the buffers for only one channel are shown. As mentioned previously, the ACK messages are typically returned from the receiver to the sender for each packet which verifies the packet arrived error-free. In the ACK packet header is an Advertised Window (AW) that indicates to the sender what amount of data that the receiver can handle.

Apart from the TCP mechanism for dealing with congestion, i.e. the receiver writing the appropriate AW value according to the remaining space in its buffer, a process of TCP optimization is applied to packet transfers within the wireless network. In accordance with a first aspect the invention, the RNC 130 monitors the buffer levels and modifies the AW in the TCP ACK headers prior to being forwarded to the sender.

In the RNC, buffer overflows are monitored and limited at the PDCP layer. The Radio Link Control layer (RLC) includes software that performs monitoring tasks whereby the downlink buffers for each channel are monitored for remaining free capacity. The RLC layer is a protocol used for radio transmission within wireless telecommunication networks which, among other things, performs segmentation and retransmission of voice and other data when needed. The data occupancy level in the buffer at the PDCP level can be measured in segments, where in accordance with the present embodiment, comprises a buffer capacity of ten segments. A segment in the context of the present invention can vary from tens of bytes to several thousands of bytes (e.g. for voice, TCP ACK etc may be 1.5K bytes).

It should be noted that the capacity measurement using segments in the described embodiment is arbitrary and that other techniques for defining capacity may be used. By way of example, one simple technique functioning in accordance with the invention e.g. when a downlink buffer reaches 8 segments of data, a PDCP level buffer management software agent modifies the AW a returning ACK 330 to 8K bytes from an initial value of 15K bytes, for example. The AW field tells the sender 310 to send 8K bytes at a time from 15K bytes thereby reducing the transmission rate so that the receiver's buffer data occupancy level can drop below the threshold. Since the AW field is indicative of available buffer space, the value reflects the maximum rate by which the sender may transmit without causing buffer overflow at the receiver. It should be noted that these are exemplary values given for the purposes of illustrating the invention.

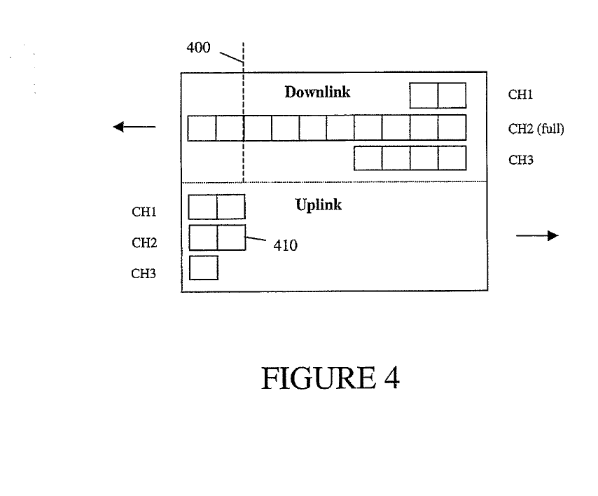

FIG. 4 shows a depiction of the arrangement of the PDCP buffer memory in the RNC. The arrangement illustrates data contained in the downlink buffers for exemplary channels 1-3 and their corresponding uplink buffers. It should be noted that buffers for as many as 80 or more channels per block and as many as 4 blocks operating for full capacity of approximately 320 or more possible active channels may be included. The channel capacity is typically manufacturer dependent in which the values stated are exemplary. As shown, each of the downlink (DL) and uplink (UL) buffers have capacity for 10 exemplary segments of data. The figure illustrates an exemplary situation where the CH2 (channel 2) DL buffer is completely filled with data and with CH1 is filled with only 2 segments of data and CH3 filled with 4 segments.

In accordance with the first aspect of the invention, the buffer management agent detects that the DL buffer contains more than the threshold of e.g. 8 segments (indicated by reference numeral 400) and moves to modify the AW in e.g. ACK 410 by specifying a lower value for transmission, for example, a value of half of the current value. If this proves to still be too high, the data will remain above the threshold and a further reduction is made, for example, the rate could again be reduced in half. The reductions can continue if necessary until the buffer occupancy level is reduced below the threshold level thereby relieving the congestion. It should be noted that the AW value may be lower in smaller increments than that exemplified above e.g. by a third or a forth of the current value. Moreover, the reductions should not be made to a level where the value falls below the Maximum Segment Size (MSS), which was determined when the TCP connection session was established. By way of example, a typical MSS value can be 1500 bytes, 1024 bytes, or 512 bytes.

In a second aspect of the invention, some ACKs can be intentionally delayed i.e. held in the UL buffer for a certain period of time before forwarding them. By withholding the ACK for a brief time, the TCP sender temporarily delays sending packets thereby allowing time for the buffer to clear. The technique of delaying the ACKs provides for a ‘softer’ method of controlling the packet flow as compared to the jolt of a relatively large changes in the flow rate caused by modifying the AW. Another advantage of using delay is that it makes the variations in the transmission rate smoother leading to better bandwidth utilization and also has the effect of making the TCP traffic less bursty. Bursty traffic can lead to the onset of congestion whereby excessive bursts of traffic can eventually lead to buffer overflows. Similarly, a buffer threshold for the data occupancy level is used for this technique.

Under certain conditions, such as when the data in the buffer is below the threshold, the ACKs are not delayed. On the other hand, when the data is above the threshold, all the ACKs are delayed for the minimum amount of time t_{d} e.g. the amount of time it takes to transmit one full segment over the radio interface i.e. enough time to empty the buffer by one segment. The delay period t_{d} can of course be increased or decreased as necessary to empty multiple segments or less than one segment, for example. One way of determining t_{d} would be to use a relatively simple timer to measure this minimum time value. A more detailed discussion on delaying techniques for TCP acknowledgements, the interested reader may refer to “Flow Control in a Telecommunication Network”, PCT publication WO 99/04536, published on Jan. 28, 1999, and assigned to the same Applicant as herein.

In a third aspect of the invention, the combination of ACK delay and modifying the AW (sometimes referred to as Window Pacing) can provide even more control in reducing the transmission rate of the TCP sender. An effective technique by which the RNC can relieve congestion would be to first attempt delay acknowledgements and then use Window Pacing if delaying ACKs proves not to be enough.

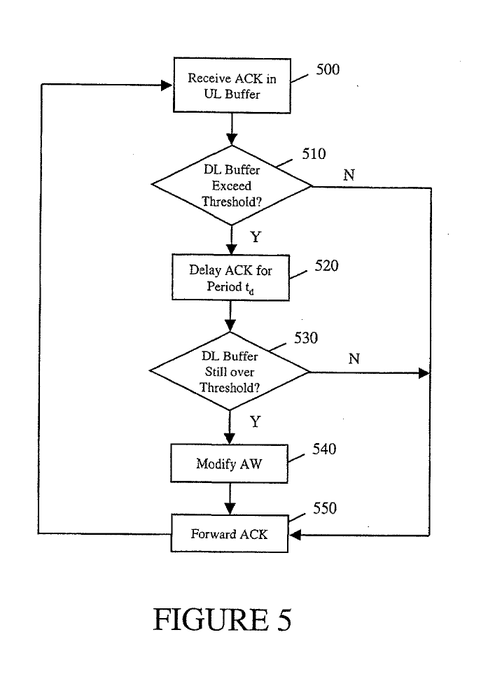

FIG. 5 is a flow diagram illustrating an exemplary congestion control procedure in accordance with the present invention. The RLC layer buffer management algorithm initiates the procedure on a per channel basis when an ACK enters the UL buffer for a specific channel, as shown in step 500. Once the ACK has been received, the associated DL channel buffer is checked to determine its current capacity status i.e. if the data contained is above a predetermined threshold, as shown in step 510. If the data in the buffer is below the threshold the ACK is forwarded normally to the TCP sender in step 550. When the data is found to exceed the threshold the ACK is delayed for a period t_{d} (step 520) according to the delay technique described previously.

Once the delay of tₙ has elapsed, the DL buffer for the channel is checked again to determine if the data in the buffer has fallen below the threshold, as shown in step 530. If it has then the ACK is forwarded in the normal way (step 550). If the data in the buffer remains above the threshold then step of modifying the AW in the ACK header is taken as described earlier, and shown in step 540. Following modification of the AW, the ACK is forwarded to the TCP sender in accordance with normal procedures, as shown in step 550.

The value in the AW can be reduced by a fixed amount or ratio such as half the existing value (until it reaches the MSS) or in way that is directly proportional to the amount over the threshold and the current transfer rate. By way of example, if the DL buffer is full and the transfer rate is very high, e.g. near the theoretical upper limit range of 1-2 Mbps, then a substantial reduction to reduce the flow rate quickly would be most effective. In practice, a flow rate above 400 kbps could be considered high enough to warrant some action. On the other hand, if the data in the buffer is hovering just above the threshold with a moderate flow rate, a less severe reduction may be introduced such as a quarter or an eighth of the existing value, for example. For added robustness the algorithm calculates the average queue length (data occupancy level) in the buffer in order to find an optimal value for the AW. It should be noted that the figures mentioned are exemplary and that better results may be achieved by “fine-tuning” the figures in accordance with the conditions experienced with a particular networks.

An exemplary algorithm using the average queue length for congestion control can be implemented by checking current queue length (QueueLength) in the downlink buffer periodically e.g. every x seconds. Then a calculation of the average queue length (AQL) may be calculated as follows:

AQL=(1−X)AQL(−1)+X*QueueLength

If (AQLg<20%(BufferSize)) then

A=A+Y (Y=0.125)

If (AQL>60%(BufferSize)) then

A=A*Z(Z<1)

The advertise window (AW) value is then calculated as follows:

AW=A*log(BufferSize−QueueLength)

where X is a gain factor which is typically small (such as 1/128) so that large variations in the QueueLength do not disproportionately affect the AQL value. A (initially set to 1) is used to calculate the window value and where it varies slowly as the buffer occupancy increases or decreases. Y is typically a small value such as 0.125 or ⅛. Z is a variable that decreases A if less than 1 but is not set too small in order to avoid rapid variations, e.g. a value that works well with the invention has Z set to 0.98.

When a new ACK is received in the uplink buffer the AW field is modified according to the following condition:

If AW<current AW AND AW>MSS (Maximum Segment Size), then Modify the AW field in the TCP ACK with a calculated AW value (AW_calc) that is:

AW_{—}calc=AW*MSS.

In an exemplary algorithm that does not use the average queue length that functions by increasing the AW only when the buffer is empty and decreasing the AW if the queue size exceeds the threshold. The algorithm may be expressed as follows:

If (QueueLength=0) then

A=A+Y (where Y=0.125)

Else

If (QueueLength>60%(BufferSize) then

A=A*Z (where Z<1 e.g. Z=0.98)

AW=A*log(BufferSize−QueueLength)

It should be noted that the values for the variables may depend on the end-to-end delay experienced by TCP connections and on the bandwidth of available along the path whereby suitable values can be obtained by experimentation.

In still another aspect of the invention, instead of simply delaying acknowledgements, some ACKs can be discarded in what essentially amounts to a permanent delay. Discarding ACKs may be preferable when the risk of the DL buffer overflow is very high since the TCP sender will then dramatically reduce its sending rate under the assumption that congestion has occurred.

Improved system performance can be achieved when the queue length is known as illustrated in the above techniques. By way of example, the AW can be modified to increase the packet sending rate when the downlink buffer is empty which makes more efficient use of resources during packet transmissions.

The invention can also be utilized for congestion control when a mobile terminal is uploading data to a TCP receiver, for example. This can be done by reversing the roles of the DL buffer and the UL buffer as described in the embodiment of the invention. However, congestion in this direction is relatively unlikely since bit rates in wireless systems are significantly lower than that of wired packet networks. Nonetheless, uploading congestion may occur when transferring data to another mobile client either on the same network or another packet switched network, for example. This can likely occur when performing a mobile-to-mobile transfer to a distant location, e.g. other side of the world, in which the packets are transferred over the Internet that may incur various delays along the way.

Although the invention has been described in some respects with reference to a specified embodiment and related aspects thereof, variations and modifications will become apparent to those skilled in the art. In particular, it is possible for inventive concept to be applied to packet streaming protocols other than TCP that provide the ability to specify a suitable transmission rate via feedback. It is therefore the intention that the following claims not be given a restrictive interpretation but should be viewed to encompass variations and modifications that are derived from the inventive subject matter disclosed.

1. A wireless telecommunication system comprising a packet switched network for sending and receiving data traffic between a mobile terminal and a data packet sender wherein the system comprises a plurality of uplink buffers and downlink buffers wherein each uplink and downlink buffer pair is associated with a specific communication channel for use by the mobile terminal, said system being
characterized in that
the system includes means for controlling excessive congestion of packets accumulating in said buffers in a network element between the sender and the receiver terminals during a data transfer.

2. A system according to claim 1 characterized in that said system is a UMTS wireless telecommunication system that further comprises a circuit switched network for providing voice services.

3. A system according to claim 1 characterized in that the data packet sender is a TCP based server functionally connected to said wireless telecommunication system via the Internet.

4. A system according to claim 1 characterized in that said means for congestion control is a software algorithm.

5. A method of controlling packet congestion in a wireless telecommunication system comprising a packet switched network for sending and receiving data traffic between a mobile packet receiver and a data packet sender, and wherein the system further comprises a plurality of uplink buffers and downlink buffers wherein each uplink and downlink buffer pair is associated with a specific communication channel for use by the mobile terminal during a data transfer, said method is characterized in that congestion caused by packets accumulating in said buffers in a network element between the sender and receiver terminals during the data transfer is controlled by instructing the sender to reduce the rate at which packets are transmitted via an acknowledgement message (ACK) forwarded by the mobile packet receiver to the packet sender.

6. A method according to claim 5 characterized in that the method further comprises the steps of:
checking the queue length in the downlink buffer associated with the packet transfer;
comparing the queue length to a predetermined threshold;
receiving the ACK in the uplink buffer associated with the packet transfer from the mobile terminal; and
wherein the ACK comprises an Advertised Window (AW) field which is modified to a value that is indicative of the free capacity remaining in the downlink buffer when the queue length exceeds the threshold.

7. A method according to claim 5 characterized in that the wireless telecommunication system operates in accordance with UMTS specifications.

8. A method according to claim 6 characterized in that the packet transfer is transmitted in accordance with TCP/IP packet data protocol.

9. A method according to claim 6 characterized in that a step in which the ACKs received in the uplink buffer are delayed for a period of time prior being forwarded to the sender.

10. A method according to claim 5 characterized in that the transmission rate of the sender is reduced by delaying the ACKs received in the uplink buffer for a period of time prior being forwarded to the sender.

11. A method according to claim 5 characterized in that the delay period is equivalent to the time it takes for the mobile receiver to receive a segment of data from the downlink buffer over the radio interface.
